(19) United States
(12) Patent Application Publication
(10) Pub. No.: US 2025/0196347 A1
(43) Pub. Date: Jun. 19, 2025

(54) DISPATCHER-EXECUTOR SYSTEMS FOR MULTI-TASK LEARNING

(71) Applicant: DeepMind Technologies Limited, London (GB)

(72) Inventors: Martin Riedmiller, Balgheim (DE); Roland Hafner, Balgheim (DE); Tim Hertweck, Lauchringen (DE)

(21) Appl. No.: 18/981,230

(22) Filed: Dec. 13, 2024

Related U.S. Application Data
(60) Provisional application No. 63/610,368, filed on Dec. 14, 2023.

(51) Int. Cl. B25J 9/16

(52) U.S. Cl. CPC B25J 9/1661; B25J 9/163; B25J 9/1679; B25J 9/1697

(57) ABSTRACT

This specification describes systems and methods, implemented as computer programs on one or more computers in one or more locations, for controlling an agent to perform multiple different tasks in an environment. The described techniques partition the architecture of a controller into a dispatcher that understands the environment and an executor that understands how to control the agent, with a control channel between them that structures the partitioning. This allows implementations of the controller to generalize better.

### CROSS-REFERENCE TO RELATED APPLICATION

This application claims priority to U.S. Provisional Application No. 63/610,368, filed on Dec. 14, 2023. The disclosure of the prior application is considered part of and is incorporated by reference in the disclosure of this application.

### BACKGROUND

This specification generally relates to controlling agents using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Implementations of the described techniques use reinforcement learning. In a reinforcement learning system an agent interacts with an environment by performing actions that are selected by the reinforcement learning system in response to receiving observations that characterize the current state of the environment. The described systems select actions to be performed by the agent in response to receiving a given observation in accordance with an output of a neural network.

### SUMMARY

This specification describes systems and methods, implemented as computer programs on one or more computers in one or more locations, for controlling an agent to perform tasks in an environment. The described techniques partition the architecture of a controller into a dispatcher that understands the environment and an executor that understands how to control the agent, with a control channel between them that structures the partitioning. This allows implementations of the controller to generalize better.

In one aspect there is described a computer-implemented method of controlling an agent acting in an environment to perform a task of a plurality of possible tasks.

The method involves obtaining a task description that identifies the task to be performed. The method processes the task description and, at each of a plurality of sub-task execution time steps, an observation characterizing a state of the environment at the time step using a (trained) dispatcher neural network system, i.e., in accordance with learned parameters of the dispatcher neural network system, to generate an executor instruction. The executor instruction is used for controlling a (trained) executor neural network system to perform the sub-task for the time step. The sub-task may be referred to as a skill. The executor instruction comprises a set of tokens that encodes a representation of relevant aspects of the environment for the task, more particularly for the sub-task. The executor instruction is processed using the (trained) executor neural network system to generate an action selection output, in particular for performing a set of one or more sub-task actions for executing the sub-task of the task for the sub-task execution time step. The executor neural network system implements a learned action selection policy to select actions for the agent, to perform the sub-task or skill using information in the executor instruction.

According to a further aspect of the disclosure there is provided one or more non-transitory computer storage media storing instructions that when executed by one or more computers cause the one or more computers to perform operations of the above method.

According to a further aspect of the disclosure there is provided a system comprising: one or more computers; and one or more storage devices communicatively coupled to the one or more computers, wherein the one or more storage devices store instructions that, when executed by the one or more computers, cause the one or more computers to perform operations of the above method.

The subject matter described in this specification can be implemented in particular embodiments so as to realize one or more of the following advantages.

A controller neural network system and method as described herein can generalize better than some other techniques. For example, it can learn to perform a general task from a few particular examples of the task. In some cases it can perform a new task, different to any it has been specifically trained on but of a similar general character, without further training. That is, implementations of the system can exhibit zero-shot learning.

The described format of executor instructions enables compositionality, i.e., it allows tokens to be combined to specify a particular task. It can also permit or encourage tokens that encode information with a maximum degree of abstraction, under the constraint that the task can still be executed successfully. In principle the executor instructions also provide an intermediate language that can be interrogated to explain the actions selected. That is some implementations may provide human interpretability of the behaviour of the system, which may be useful for trustworthiness, safety, regulatory, or other purposes.

The described techniques allow the controller neural network system to be trained with less training data than some other approaches, because the system can generalize from a reduced number of examples of a task being performed. This is facilitated by the described structure of the executor instructions.

More generally, implementations of the describe techniques facilitate training a system to control an agent, with substantially reduced training data and/or computing resources compared to some other approaches.

### BRIEF DESCRIPTION OF THE FIGURES

FIG. 1 shows an example neural network system.

FIG. 2 is a flow diagram of an example process for controlling an agent to perform a task.

FIG. 3 shows an example computing system for implementing the neural network system of FIG. 1.

FIG. 4A shows an example agent in a real-world environment.

FIG. 4B shows an example agent in a simulated environment.

FIG. 5 shows a further example neural network system.

FIG. 6 shows an example of the performance of techniques described herein.

FIG. 7 shows a further example of the performance of techniques described herein.

FIG. 8 shows a further example of the performance of techniques described herein.

### DETAILED DESCRIPTION

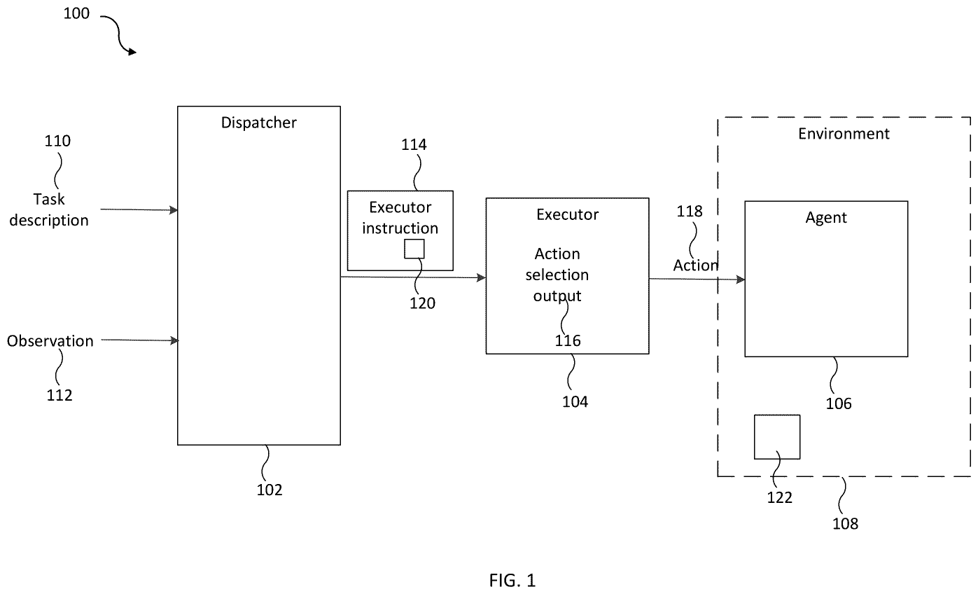

FIG. 1 shows an example neural network system 100 (otherwise referred to herein as a controller system 100) comprising a dispatcher neural network system 102 (otherwise referred to herein as a dispatcher 102), an executor neural network system (otherwise referred to herein as an executor 104), and an agent 106 in an environment 108. The dispatcher 102 and executor 104 are operable to control the agent 106 using methods described herein. In broad terms, the role of the dispatcher is to semantically understand a task that the agent 106 is to perform, while the role of the executor is to control the agent 106 to perform the task.

The environment 108 may further comprise one or more entities 122, which may be relevant to a task; for example, a task may require the agent 106 to interact with an entity 122 in the environment 108.

The dispatcher 102 is configured to receive a task description 110 that identifies a task that is to be performed by the agent 106. Such a task may be performed over a certain period of time which may be divided into time steps (otherwise referred to herein as sub-task execution time steps). The dispatcher 102 is further configured to receive an observation 112 at each time step, each observation 112 characterizing a state of the environment 108 at that time.

The dispatcher 102 is configured to process the task description 110 and each successive observation 112 to generate an executor instruction 114 at each time step. The executor instruction 114 comprises one or more tokens 120 that encode a representation of aspects of the environment 108 that are relevant to a particular stage of executing the task corresponding to the task description 110 (these stages are otherwise referred to herein as sub-tasks).

In embodiments, it is envisioned that the executor instruction 114 contains only a subset of all the information about the environment 108 that is available to the dispatcher 102. In particular, the tokens 120 of the executor instruction 114 may encode a representation of only those aspects of the environment 108 that are necessary in order for the executor 104 to control the agent 106 correctly to perform the task (or one or more sub-tasks). This enhances the ability of the executor 104 to be applied to different tasks, as will be described in more detail below.

The dispatcher 102 is configured to communicate the executor instruction 114 to the executor 104. The executor 104 is configured to receive the executor instruction 114 and process the executor instruction to generate an action selection output 116. The executor 104 is further configured to use the action selection output 116 to select an action 118, and to then use the action 118 to control the agent 106 to perform the task corresponding to the task description 110, or otherwise to perform one or more sub-tasks of the task. In some implementations there can be multiple executors 104 associated with a shared dispatcher 102, each specialized for a different task (skill).

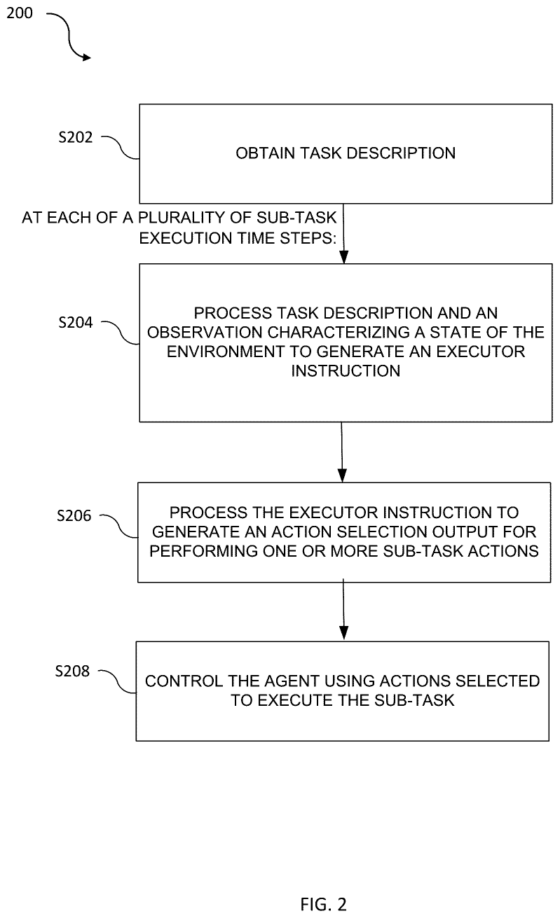

FIG. 2 is a flow diagram of an example process 200 for controlling an agent acting in an environment to perform a task of a plurality of possible tasks.

For example, the method 200 may be performed by the dispatcher 102 and the executor 104 to control the agent 106 in the environment 108 to perform a task.

At step S202, the method comprises obtaining a task description. The task description identifies the task to be performed.

For example, the dispatcher 102 may receive the task description 110.

The following steps S204, S206, and S208 are performed at each of a plurality of sub-task execution time steps.

At step S204, the method comprises processing the task description and an observation characterizing a state of the environment at the time step, using a dispatcher neural network system, to generate an executor instruction. The executor instruction comprises a set of tokens that encodes a representation of aspects of the environment relevant to the sub-task.

For example, the dispatcher 102 may process the task description 110 and the observation 112 to generate the executor instruction 114 comprising the token or tokens 120.

At step S206, the method comprises processing the executor instruction, using an executor neural network system, to generate an action selection output for performing a set of one or more sub-task actions for executing a sub-task of the task.

For example, the executor 104 may process the executor instruction 114 to generate the action selection output 116. The action selection output 116 may, for example, be generated according to an action selection policy of the executor 104.

At step S208, the method comprises controlling the agent using actions selected according to the action selection output to perform the set of one or more sub-task actions for executing the sub-task.

For example, the executor 104 may control the agent 106 to perform an action 118 selected according to the action selection output 116.

In some implementations, e.g., where the executor neural network system 104 is able to perform multiple different sub-tasks, the executor instruction 114 can include information that specifies the sub-task to be performed. In some implementations the sub-task to be performed may be implicit or, as described later, may be defined by choosing an executor neural network system 104 to perform the particular sub-task.

That is, in some implementations the executor neural network system 104 does not receive the task description 110, or a version of the task description 110, as an input.

The executor instruction 114 encodes relevant aspects of the environment 108 for the sub-task, e.g., the locations or characteristics of one or more objects in the environment 108, and the executor neural network system 104 is able to use this information to perform the sub-task. In implementations, however, the executor instruction 114 omits information that is not relevant to the particular sub-task being performed, so that the executor neural network system 104 is constrained to rely on a generalized description of the environment 108 when performing the sub-task.

The form of the executor instruction 114 can be learned or hand-engineered, or both, e.g., a format of the executor instruction 114 may be defined but the tokens 120 encoding aspects of the environment 108 may be learned.

The agent 106 is controlled using actions 108 selected according to the action selection output 116, to perform the set of sub-task actions to execute the sub-task. For example the agent 106 may comprise an agent control system, coupled to the action selection policy output 116, to provide control signals in accordance with the selected actions to control the agent 106 to perform the sub-task.

In some implementations the action selection output 116 is used to select the set of one or more sub-task actions for the agent 106 at each of the sub-task execution time steps. That is, the executor instruction 114 may be provided for each of a succession of “primitive” time steps for performing the sub-task. Each primitive time step can be one at which the executor neural network system 104 generates an action selection output 116 for selecting one or more actions 118 to be performed at the primitive time step for performing the sub-task. That is each primitive time step may correspond to a respective one of the sub-task execution time steps. In some implementations the action selection output 116 is used to select an action 118 for the agent 106 at each of a succession of primitive time steps for performing the sub-task, and the primitive time steps are more frequent than the sub-task execution time steps. That is, the executor instruction 114 may be provided for multiple of “primitive” time steps. The executor instruction 114, e.g., a single executor instruction 114, may be used to generate an action selection output 116 for selecting one or more actions 118 to be performed at each of a series of primitive time steps, for performing the sub-task.

The action selection output 116 may define an action 118 directly, e.g., it may comprise a value used to define a continuous value for an action 118, such as a torque or velocity; or it may define, e.g., parameterize, a continuous or categorical distribution from which a value defining the action 118 may be selected, e.g., by selecting a mean value or by sampling from the distribution; or it may define an action 118 by defining a set of scores, one for each action 118 of a set of possible actions, for use in selecting the action 118, e.g., by selecting an action 118 with the highest score or by selecting an action 118 from a distribution represented by the scores. The action selection output 116 may be able to define an action 118 that is a non-action, i.e., it may be able to define that the agent 106 is not to act at a particular time step.

In implementations the dispatcher neural network system 102 divides the task into sub-tasks and generates the executor instruction 114 by selecting, from the observation 112 characterizing the state of the environment 108 at the sub-task execution time step, a subset of information from the observation 112 relevant to the sub-task being executed at the time step. In implementations the executor neural network system 104 processes the subset of information from the observation 112 relevant to the sub-task being executed at the time step, to generate the action selection output 116 for performing the set of sub-task actions.

In implementations the dispatcher neural network system 102 generates the set of tokens 120 such that each token 120 represents one or more aspects of an entity 122 in the environment 108 that is relevant to performing the task. For example, aspects of an entity 122, e.g., object, in the environment 108 may comprise characteristics of the object, or characteristics of the object in relation to other objects and/or in relation to a scene representing the observation 112 of the environment 108. The entity 122 can be an object that the agent 106 is capable of manipulating.

In implementations generating the set of tokens 120 comprises generating one or more (different) respective tokens 120 to represent the one or more aspects of each (different) respective entity 122 in the environment 108. That is, different tokens 120 can represent different respective entities 122 in the environment 108. Each token 120 can encode a disentangled aspect of an entity 122 in the environment 108, i.e., a variable that defines how the entity 122 appears in the observation of the environment 108, such as the location or pose of an object in the environment 108. Such a representation is particularly appropriate for a real-world environment 108 in which how an entity 122 appears in an observation 112 of the environment 108 tends to decompose into separate factors of variation, such that factors relevant to a particular sub-task can be selected. Information about a scene within which the entities 122, e.g., objects, are located may be represented explicitly by one or more tokens 120, or can be represented implicitly by the set of tokens 120.

As an example, in some applications the tokens 120 can represent the state of a mechanical agent 106, such as the configuration of a robot arm, or more generally the pose or position, velocity, or acceleration of an object or entity 122 in a real-world environment. In some other applications the tokens 120 can represent the state of a machine or of an industrial plant or data center, e.g., representing sensed electronic signals such as sensed current, voltage, temperature, or other signals.

In implementations generating respective tokens 120 representing different respective entities 122 in the environment comprises processing the observation 112 characterizing the state of the environment 108 at the time step, and the task description 110, using the dispatcher neural network system 102.

In general in implementations of the described techniques, whether or not based on generating or processing tokens, the dispatcher neural network system 102 selects a subset of the entities 122 (“target objects”) in the environment 108 based on the task description 110, i.e., just those relevant to the sub-task, for use in performing the sub-task. This can be done, e.g., by computing a dense (per pixel) representation of the target object(s), which can be referred to as a filter, e.g., based on one or more of an object or semantic segmentation, object edge detection, and an object pointer (indicating, e.g., a centroid of an object).

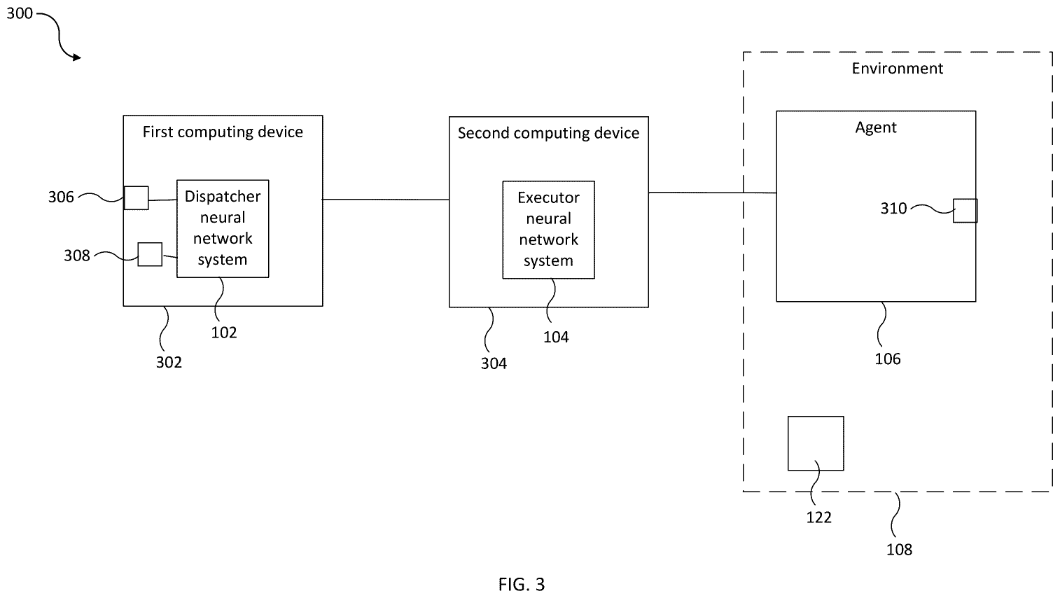

In some implementations the observation 112 characterizing the state of the environment at the time step comprises an image observation from one or more image sensors 310 (described below with reference to FIG. 3).

Generating the tokens 120 representing different respective entities 122, e.g., objects, in the environment 108 can then involve processing the task description 110 and pixels of the image observation at the sub-task execution time step, using the dispatcher neural network system 102, to (identify and) select one or more objects in the image observation, based on the task description 110, for use in performing the sub-task. The set of tokens 120 can then be generated such that each one of the one or more objects is characterized by one or more respective ones of the tokens 120.

In some implementations a location of each of the one or more objects is characterized by a respective token 120. For example this can involve generating a token 120 that defines an outline or partial outline of an object, or that defines a location of a specified part, e.g., a center of mass of an object. In some implementations a pose and/or shape of an object is defined by a respective token 120. In general tokens 120 may represent any aspect of an object that is useful for performing a task or sub-task.

In some implementations the tokens 120 of the set of tokens 120 may be partially or wholly hand-engineered, e.g., defined by a system architecture. In some implementations at least some tokens 120 of the set of tokens 120 generated by the dispatcher neural network system 102 encode a learned representation of the aspects of the environment 108 relevant to the sub-task, e.g., a learned representation of one or more objects in the observation 112 of the environment 108.

Thus the executor neural network system 104 can be configured to process an executor instruction 114 that includes (just) relevant aspects of the environment 108 as characterized by the observation 112, and the dispatcher neural network system 102 can extract these for the executor neural network system 104, based on the task description 110, so that the sub-tasks can be appropriately performed by the executor neural network system(s) 104 to perform that task.

As an example, the executor neural network system 104 may have been trained to stack one block on top of another, and the task or sub-task may be to stack a green block on top of a blue block. In this example the dispatcher neural network system 102 can identify the green block as the block to be stacked and the blue block as the base block, and generate tokens 120 for a corresponding executor instruction 114 for the executor neural network system 104 to implement. In another example, an executor neural network system 104 may have been trained to control an autonomous vehicle to turn left or turn right taking account of hazards such as an obstacle in the way, the task description 110 may describe a navigation task, and the dispatcher neural network system 102 can generate an executor instruction 114 for performing a turning sub-task and may include one or more tokens 120 indicating obstacle(s) (if present). Depending on the implementation the sub-tasks may be at higher or lower levels of generalization than the preceding examples.

More generally, the executor neural network system 104 may have been trained to perform a sub-task based on instructions that indicate locations of one or more objects in the observation 112 characterizing the environment 108, and the dispatcher neural network system 102 may have been trained to identify the locations of relevant objects for a sub-task based on the task description 110.

In some implementations the observation 112 characterizing the state of the environment 108 (which includes the agent 106) at the time step can include an additional sensor 310 or other observation. This may be obtained from one or more sensors 310, e.g., one or more additional sensors, in the environment 108, e.g., one or more proprioceptive sensors of a robot or other mechanical agent 106. In general this additional, e.g., sensor 310, observation 112 may be obtained from the environment 108 in any appropriate manner according to the particular application (some example applications are described later). The additional, e.g., sensor, observation 112 can be processed using a sensor encoder neural network to generate a set of sensor feature vectors representing the additional sensor observation. In some implementations the executor instruction 114 and the set of sensor feature vectors are processed using the executor neural network system 104 to generate the action selection output. In some implementations the executor instruction 114, more particularly the set of tokens 120, can be generated based on a combination of the image observation and the additional sensor observation.

In some implementations the executor instruction 114 and the set of sensor feature vectors are processed using the executor neural network system 104 to generate the action selection output 116. This can facilitate the executor neural network system 104 determining actions 118 for performing the sub-task.

In some implementations generating the set of tokens 120 involves selecting each token 120 from an observation description language comprising tokens that describe (represent) one or more of: objects represented by the observation 112; aspects, e.g., characteristics, of objects represented by the observation 112; and a scene represented by the observation 112. In some implementations the tokens 120 are not discrete (i.e., are not selected from a vocabulary of discrete tokens), and there need not be a finite number of tokens 120. In some implementations the tokens 120 may be selected from a vocabulary of possible tokens, optionally with some tokens modifying others to represent an object, in a similar way to natural or computer language. In some implementations the set of tokens 120 may comprise a sequence of tokens 120; then the order of the tokens 120 in the sequence may be, but need not be, meaningful. In implementations use of an observation description language reduces the amount of information from the observation 112 provided to the executor neural network system(s) 104, ideally to a minimum needed for the executor neural network system(s) 104 to perform the subtasks. This in turn helps implementations of the controller system 100 to make efficient use of available data, particularly during training.

In some implementations there can be multiple executor neural network systems 104, each configured to perform a different sub-task or skill. The set of tokens 120 generated by the dispatcher neural network system 102 can include an executor identifier token for the sub-task execution time step identifying one of the executor neural network systems 104 to perform the sub-task. The executor instruction 114 can then be processed using the identified executor neural network system 104 to generate the action selection output 116. This may, but need not, involve processing the executor identifier token to select one of the executor neural network systems 104; in some implementations an executor neural network system 104 may respond only to executor instructions 114 directed at itself.

The task description 110 may comprise a text sequence, e.g., a natural language text sequence, that characterizes the task to be performed by the agent 106 in the environment 108. An encoded representation of the text sequence, e.g., a text embedding, may then be generated. Processing the task description 110 and the observation 112 characterizing the state of the environment 108 at a time step, using the dispatcher neural network system 102, can then involve processing the observation 112 conditioned on the encoded representation of the text sequence to generate the executor instruction 114 comprising the set of tokens 120. In implementations the set of tokens 120 may comprise a sequence of tokens 120 each representing a different respective aspect of the observation 112 characterizing the state of the environment 108.

In general the neural network systems described herein, e.g., the dispatcher neural network system 102 and the executor neural network system 104, may include neural networks having any suitable architecture, such as one or more feed forward neural network layers, one or more recurrent neural network layers, one or more convolutional neural network layers, one or more attention neural network layers, or one or more normalization layers.

In some implementations, e.g., where the task description 110 comprises a text sequence such as a natural language text sequence, the dispatcher neural network system 102 may comprise a transformer-based multimodal machine learning model, e.g., a VLM (Visual Language Model).

A transformer-based machine learning model is one that includes a neural network with one or more transformer blocks. A transformer block typically includes an attention or self-attention neural network layer, which may be followed by a feedforward neural network layer. Each attention neural network layer has an attention layer input for each element of the input and is configured to apply an attention mechanism over the attention layer input to generate an attention layer output for each element of the input. In implementations the attention mechanism computes a similarity between a query and a set of key-value pairs. In implementations one or both (in the case of self-attention) of the query and the set of key-value pairs are determined from the attention layer input.

In implementations the multimodal machine learning model has a first modality input to receive the text sequence and a second modality input to receive the observation 112 characterizing the state of the environment 108 at the time step. The second modality input is configured to receive a different type of data to text, e.g., it may comprise visual input to receive a still or moving image (video), or audio data representing values of an audio waveform (such as instantaneous amplitude data or time-frequency domain data), or data representing other sensor observations such as proprioceptive observations of the environment. There may be more than two different inputs, each configured to receive a different modality of input data.

The transformer-based multimodal machine learning model may be configured to jointly process an encoded version of the text sequence and an encoded version of the observation 112, e.g., as feature vectors or a feature map, in accordance with learned parameters of the multimodal machine learning model, to generate the executor instruction 114.

The dispatcher neural network system 102 may comprise one or more pre-trained neural networks, e.g., it may be based on the “Segment Anything” model (Kirillov et al. arXiv:2304.02643); and/or it may be trained from scratch or fine-tuned for a particular application.

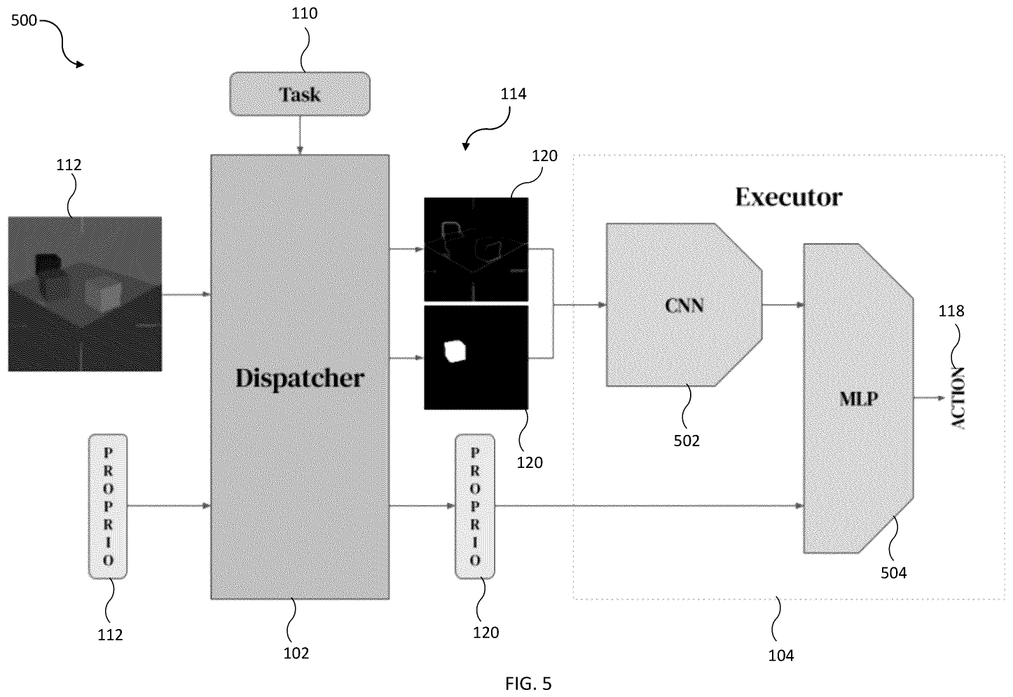

The executor neural network system 104 used as described above includes one or more neural networks that may be trained from scratch, or fine-tuned based on an existing action selection policy neural network system that is able to perform a sub-task or skill. For example, in one embodiment the executor neural network system 104 may comprise a convolutional neural network (CNN) in communication with a multilayer perceptron (MLP) as shown below in FIG. 5.

As previously described, in some implementations (values of) the tokens 120 may be learned. For example a controller system 100 comprising the dispatcher neural network system 102 and the executor neural network system 104 may be trained end-to-end, by back-propagating gradients of any suitable objective function, e.g., a reinforcement learning or imitation learning objective function, through the executor neural network system 104 and executor instruction 114 into the dispatcher neural network system 102, to update learnable parameters, e.g., weights, of the dispatcher neural network system 102 and the executor neural network system 104 and optionally learnable values for the tokens 120. This may use any appropriate gradient descent optimization algorithm, e.g., Adam or another optimization algorithm.

Thus in another aspect there is described a method of training at least the executor neural network system 104 to perform one or more sub-tasks of the plurality of tasks. In some implementations the executor neural network system 104 is trained using a reinforcement learning technique, i.e., using values reinforcement learning objective function, based at least partially on rewards provided by the dispatcher neural network system 102 to the executor neural network system 104. Any reinforcement learning technique may be used.

That is, in implementations the executor neural network system 102 is trained to perform a sub-task by the dispatcher neural network system 104, e.g., based on subsidiary rewards from the dispatcher neural network system 104. For example rewards may be based on the executor neural network system 104 performing the sub-task specified by the executor instruction 114. Also or instead skills can be pre-trained.

Also or instead the executor neural network system 104 can be trained to perform one or more sub-tasks of the plurality of tasks using demonstration data from one or more demonstration agents trained to perform a particular example of the one or more sub-tasks. This can involve training at least the executor neural network system 104 using an imitation learning technique based on training data comprising demonstration data characterizing interactions of the one or more demonstration agents performing the particular example of the one or more sub-tasks in a corresponding environment to the environment 108 of the agent 106. The demonstration agent(s) may comprise humans and/or computer-implemented agent control systems.

The controller system 100 architecture, in which the executor neural network system 104 is instructed as described above, using executor instructions 114 that abstract away from a specific example of a task, enables the system 100 to learn to perform general tasks from specific examples of a task. For example, once having been trained on some example demonstrations of a particular task or sub-task, say of stacking a green block on top of a blue block, the system 100 can stack objects of other colors or shapes because the executor neural network system 104 has learned to perform that task without reference, e.g., to object color.

Training using such an imitation learning technique in general involves training the executor neural network system 104 such that actions selected according to the action selection output 116 match the actions of the demonstrating agent. Any imitation learning technique can be used, e.g., behavioral cloning, inverse reinforcement learning, or Generative Adversarial Imitation Learning (arXiv:1606.03476, Ho et al.). The training may be performed offline, i.e., based solely on the demonstration data, and/or online, e.g., to fine tune the actions using reinforcement learning. For example the executor neural network system 104 can be trained to optimize an objective function that depends on a difference between a distribution of actions 118 selected according to the action selection output 116 and a distribution of actions defined by the actions of the demonstrating agent.

Demonstration data may be obtained in any convenient manner from a human (e.g., arXiv:2112.03762 Abramson et al.) or from a computer-implemented system, e.g., by capturing multiple examples of the human or computer system performing a particular sub-task.

The dispatcher neural network system 102, e.g., based on a VLM, may be pre-trained on any suitable corpus of training data, e.g., where images or video and text are interleaved with one another, such as WebLI (arXiv:2305.18565v1 Chen et al.), and optionally fine-tuned. Also or instead the executor neural network system 104, the dispatcher neural network system 102, and/or the controller neural network system 100 can be trained using the Open X-Embodiment robotic learning dataset (arXiv:2310.08864 Open X-Embodiment Collaboration).

In general the executor neural network system 104, the dispatcher neural network system 102, or the controller neural network system 100 can be trained in a simulated environment, e.g., a simulation of a real world environment 108 in which the agent 106 will later be used to perform a task, and it can then be used to control the agent 106 to act in the real-world environment 108 that was simulated. The observations 112 may then relate to the real-world environment 108 in the sense that they are observations of the simulation of the real-world environment 108. The actions may relate to actions 118 to be performed by the agent 106 acting in the real-world environment 108 to perform the task in the sense that they are simulations of actions 118 that will later be performed in the real-world environment 108.

In some implementations the environment 108 is a real-world environment, the observations 112 comprise observations from one or more sensors 310 (described in more detail below with refer to FIG. 3) in the real-world environment, e.g., from one or more image sensors such as cameras, the agent 106 comprises a machine such as a robot or autonomous or semi-autonomous vehicle, operating in the real-world environment 108 to perform the task, and the sub-task actions are actions 118 of the machine in the real-world environment 108.

As used herein an image may be a 2D or 3D still or moving image (video) and includes a point cloud from a LIDAR system. An observation 112 characterizing a state of the environment 108 may comprise, e.g., one or more of: an image observation, e.g., pixels of an image, an audio observation, e.g., a representation of an audio waveform, and a sensor observation, e.g., from one or more mechanical or electrical/electronic sensors 310 in a real-world environment 108. In general the tokens 120 can encode any relevant aspect of the environment 108, e.g., a representation of a physical object in a real-world environment 108, or a representation of an audio object such as a discrete sound or spoken word in an audio environment 108, or a representation of an object in sensor data such as data representing a collision of part of the agent 106 with another part of the environment 108, or data representing a stalled motor, an over-temperature alert, and so forth. References herein to a “scene” are likewise to be understood as not limited to a visual scene.

Implementations of the above described techniques are adapted to implementation in a computing system comprising multiple different hardware computing devices in communication with one another, e.g., over a computer network. An example of such a computing system 300 is show in FIG. 3.

The computing system 300 comprises a first hardware computing device 302, a second hardware computing device 304, and may further comprise the agent 106 as shown if the agent is a separate physical entity (rather than, for example, a simulation executing on one of the computing devices 302, 304). The first computing device comprises a task description input 306 configured to receive the task description 110 and a memory 308 (also referred to herein as a storage device 308) storing computer code and instructions suitable for causing the first computing device 302 and/or the second computing device 304 to perform the methods described herein. The agent 106 comprises a sensor 310 (otherwise referred to herein as a sensor input 310) configured to provide the observation 112 characterising a state of the environment 108. The first computing device 302, the second computing device 304, and the agent 106 are configured to communicate, for example via a network, to exchange information in the ways described herein. Any or all of the first computing device 302, the second computing device 304, or the agent 106 may comprise a processor suitable for executing computer code to perform the operations described herein.

While a particular arrangement of the computing system 300 is shown in FIG. 3, many variations are possible. The task description input 306 and/or the memory 308 may be on the second computing device 304 rather than the first computing device 302, and/or both devices 302, 304 may be provided with either or both of a task description input 306 and a memory 308. The sensor 310 may be on one of the computing device 302, 304 instead of or in addition to being provided on the agent 106, or may be provided elsewhere in the environment 108.

The sensor 310 may, in implementations, comprise any or all of an image senor (such as a camera), a proprioceptive sensor of the agent 106 (if the agent 106 is a mechanical agent such as a robot), an audio sensor, or any other suitable sensor 310.

In some implementations the dispatcher neural network system 102 operates on a first hardware computing device (such as the first hardware computing device 302) and the executor neural network system 104 on a second, different hardware computing device (such as the second hardware computing device 304), in communication with the first hardware computing device 302 to receive the executor instruction 114 for a current time step. The first hardware computing device 302 can then be used to process the observation 112 characterizing a state of the environment 108 at a next sub-task execution time step (and the task description) to generate the executor instruction 114 for the next sub-task execution time step in parallel with the processing the executor instruction 114, using the executor neural network system 104 on the second hardware computing device 304, to generate an action selection output 116 for performing the set of one or more sub-task actions for a current sub-task execution time step. For example, the dispatcher neural network system 102 can be a large neural network system such as a VLM, e.g., as described below, and may take time to process an observation 112. With a hardware configuration as described the controller system 100 can alleviate this latency by processing a current or next observation 112 whilst the executor neural network system 104 is controlling the agent 106 to perform actions 118 for a subtask for a previous or current observation 112.

In implementations where the executor instruction 114 comprises tokens 120 from an observation description language, this can provide a common interface definition that can be used by multiple different agents 106. This in turn can facilitate sharing of resources between different agents 106.

As one example, the dispatcher neural network system 102 can be implemented on a first hardware computing device 302 and shared between one or more other agents 106 taking respective actions 118 in one or more other respective environments 108 in response to respective observations 112. The other environment(s) 108 may be all be the same environment 108 or some or all may be different environments 108. Thus different agents 106 can communicate their respective observations 112 to the dispatcher neural network system 102 which can process these, in series or in parallel (e.g., by implementing different instances of the dispatcher neural network system 102), to generate respective executor instructions 114. That is, implementations of the described techniques enable sharing of resources and also, if desired, parallelization of resources. This can be particularly useful where the dispatcher neural network system 102 has a very large number of learned parameters, e.g., greater than 109 parameters, e.g., where it comprises a foundation model such as a transformer-based multimodal machine learning model, e.g., a VLM.

The respective executor instructions 114 can be received and processed by a separate respective set of one or more executor neural network systems 104, each set implemented on a respective second, different hardware computing device 304 to control a respective agent 106. In principle different agents 106 may have different sets of one or more executor neural network systems 104. The dispatcher neural network system(s) 102 and the executor neural network system(s) 104 can operate in parallel, e.g., to reduce a latency with which actions 118 are taken in the environment(s) 108.

A further advantage of a distributed implementation of this type, where processing is shared between different hardware computing devices 302, 304, is that it can be adapted to an environment 108 as the environment 108 changes, e.g., by adding or removing agents 106 and respective sets of executor neural network systems 104.

The dispatcher neural network system 102 and the executor neural network system(s) 104 may each be either local to or remote from the agent 106. For example in a multi-agent system such as a system of multiple warehouse robots (which as used here includes autonomous vehicles that may but need not manipulate objects) the dispatcher neural network system 102 can be implemented on a server shared by the different agents 106, e.g., by the different warehouse robots. Each agent 106 may have a local copy of its set of one or more executor neural network systems 104; or a set of one or more executor neural network systems 104 may be implemented remotely from the agents 106 and shared between the agents. In another approach, each agent 106 may have a local copy of the dispatcher neural network system 102, and a set of one or more executor neural network systems 104 may be implemented remotely from the agents 106 and shared between the agents 106.

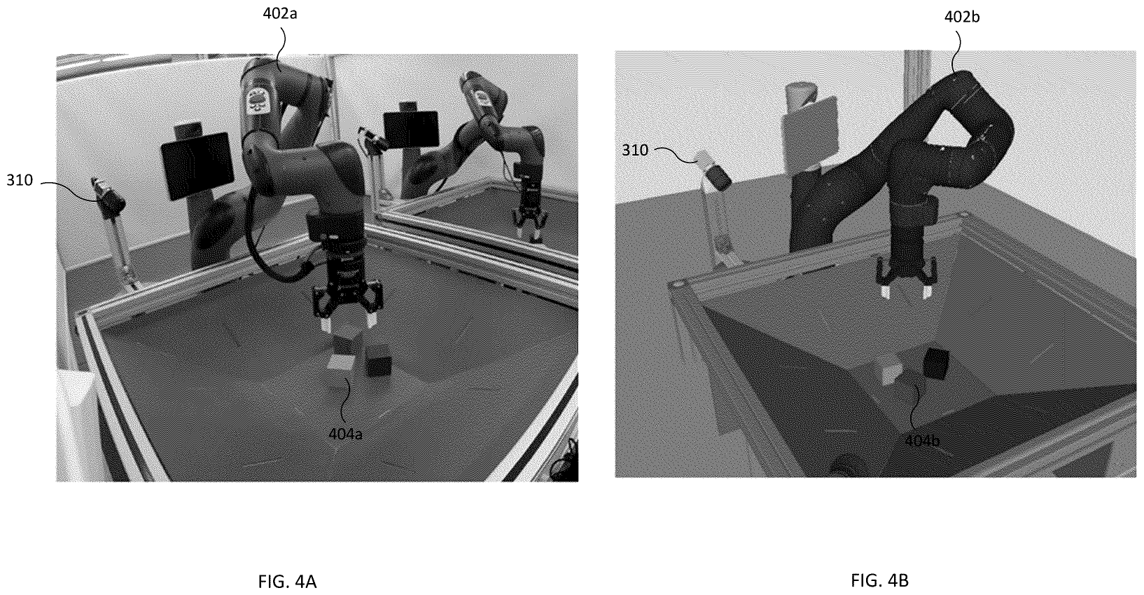

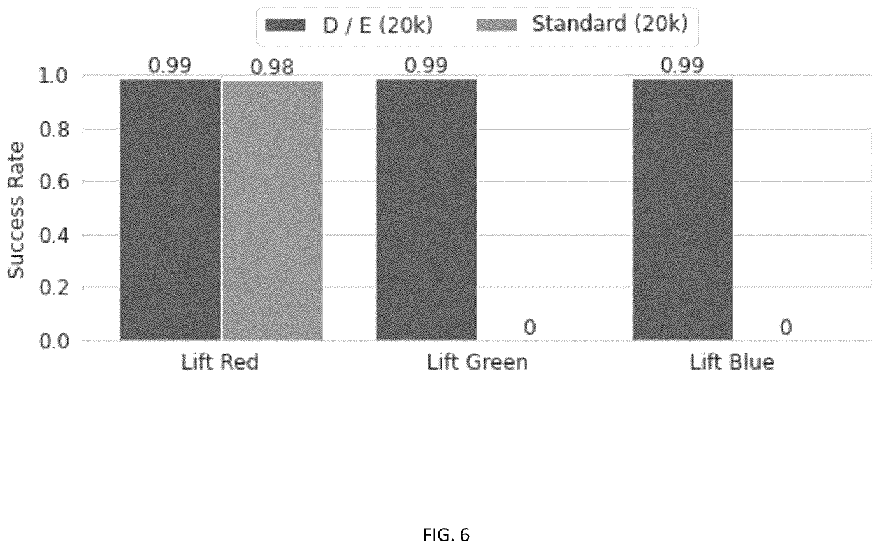

FIGS. 4A and 4B show examples of a particular agent 106 and environment 108 which will now be discussed in more detail. In FIG. 4A the agent 106 is a robotic arm 402a in a real-world environment 108, the robotic arm 402a being configured to interact with one or more blocks 404a, for example by picking up and moving the blocks 404a. In FIG. 4B the agent 106 is a virtual robotic arm 402b in a simulated environment 108 which is a simulation of the real-world environment of FIG. 4A. The virtual robotic arm 402b is configured to interact with one or more virtual blocks 404b in a simulation of the robotic arm 402a interacting with the blocks 404a. Each system further comprises a camera 310 (a physical camera in FIG. 4A and a virtual camera in FIG. 4B) which may be considered an example of the sensor 310 described above with reference to FIG. 3, and which is for providing observations 112 of the environment 108, and particularly of the blocks 404a, 404b. In particular, in the experiments described below with reference to FIGS. 6-8, three cameras 310 were used to provide the observations 112, together with proprioceptive sensors of the robot arm 402a, 402b.

For convenience the description that follows refers to target blocks 404a, 404b, but the described techniques may be used for any type of target object.

The robotic arms 402a, 402b may each act as an agent 106 controlled by a dispatcher 102 and executor 104 as described herein. The task description 110 may relate to a particular arrangement of the blocks 404a, 404b which is to be achieved by manipulating the blocks 404a, 404b with the respective robot arm 402a, 402b. The blocks 404a, 404b may be different colors as shown in FIG. 4, and the task description 110 may refer to colors of the blocks 404a, 404b. Examples of particular task descriptions 110 are given below with reference to FIGS. 6-8. Observations 112 relating to the colors and positions of the blocks 404a, 404b may be received by the dispatcher 102 from the camera 310.

Upon receiving the task description 110 and an initial observation 112, the dispatcher 102 processes the task description 110 and the observation 112 to obtain an executor instruction 114 as described herein. In particular, in the case of FIGS. 4A and 4B, where the observation 112 comprises images from the camera 310 showing the blocks 404a, 404b, the dispatcher 102 may process the images to identify the positions and colors of the blocks 404a, 404b. To produce the executor instruction 114, the dispatcher 102 may then filter the images to remove unnecessary information before providing the filtered images to the executor 104 as part of the executor instruction 114.

This filtering may be performed in any of several ways. For example, the dispatcher 102 may perform a masking operation on the images. An example of a masking operation would be to replace all pixels in each image that correspond to a target object, e.g., block 404a, 404b that is to be interacted with as part of a task to a first value, e.g., 1; otherwise, all pixels in the image are set to a second value, e.g., 0. This masked image allows the executor 104 to locate the target block 404a, 404b and infer pose and shape if needed, without receiving information such as the color of the target block 404a, 404b or information relating to the surroundings of the target block 404a, 404b that is not required by the executor 104 to perform a task or sub-task. In general a mask for one or more of the target objects, e.g., blocks, may comprise a segmentation mask, and may be obtained using any suitable image segmentation or object detection (neural network) system, of which many examples are known. Merely as one example, a version of the Segment Anything Model (SAM) may be used.

This provides compositionality and allows the executor 104 to work for a broad range of objects that may appear differently in the original observation space (e.g., the image); for example, a sub-task that requires gripping a green block or a red block using the robot arm 402a, 402b may be presented identically to the executor 104 as gripping the target block 404a, 404b highlighted in the filtered image regardless of color.

In another implementation, the filtering may involve providing information about a scene surrounding the target block 404a, 404b. This may be beneficial if, for example, there are other objects near the target block 404a, 404b that must be avoided. This broader information relating to the scene may be provided, for example, by processing the image using an edge detection algorithm and providing the resulting filtered image to the executor 104 as part of the executor instruction 114.

Also or instead a target object can be represented by an object pointer. For example, a “pointer filter” can be computed as the pixel centroid of the mask, and this can be represented as a group or blob of pixels (for example, a 5×5 pixel blob) at the respective location in the image, while setting all other pixels to a defined value, e.g., 0. This may again identify the location of the target block for the executor 104 while avoiding unnecessary information.

FIG. 5 shows an example architecture 500 which is an implementation of the controller system 100. The architecture 500 may be used, for example, to control the real and virtual systems of FIGS. 4A and 4B described above, but may also be used in any other suitable application. The architecture 500 comprises several features corresponding to the controller system 100 for which like labels are used.

In the architecture 500, the observation 112 may comprise an image, such as an image of the blocks 404a, 404b taken by the camera 310. The observation 112 may further comprise proprioceptive data of the robot arm 402a, 402b. In the case of the virtual environment 108 of FIG. 4B, this observation data may be simulated. The dispatcher 102 may process this observation 112 to obtain the executor instruction 114, which comprises one or more tokens 120 as described above. In particular, as shown in FIG. 5, the executor instruction 114 may comprise a token 120 containing some or all of the proprioceptive data received as part of the observation. Additionally or alternatively, the executor instruction may comprise a token 120 containing filtered images of the blocks 404a, 404b derived from the observation 112. As shown in FIG. 5, the filtered images may include, for example, an image filtered using an edge-detection algorithm. Additionally or alternatively, the filtered images may include an image wherein a target block is highlighted (for example, in white as shown) and all other pixels of the filtered image are set to 0. The executor 104 may comprise a convolutional neural network (CNN) in communication with a multilayer perceptron (MLP) to produce the action 118.

FIGS. 6-8 show data relating to the performance of the controller system architecture 100 (specifically the implementation 500 shown in FIG. 5) controlling the systems of FIGS. 4A and 4B in comparison to other control architectures.

In each figure the “D/E” data relates to the controller system 100 disclosed herein with a dispatcher 102 and executor 104. The “standard” data relates to a classical monolithic neural network structure. The number following the architecture (e.g., 20 k, 60 k) denotes the number of training episodes.

In the experiments of FIGS. 6-8 the controller system 100 (the “D/E” data) uses a hardcoded dispatcher and a learned executor. The dispatcher 102 receives the task description 110 and segments the according target objects (e.g., blocks 404a, 404b) using color segmentation, as well as filtering the scene using an edge operator. The executor 104 is then called, receiving the filtered images (both the segmented image and the edge-filtered image) as part of the executor instruction 114.

In the experiments of FIGS. 6-8, the “standard” architecture and the executor 104 were trained using a distributional variant of MPO (Maximum a Posteriori Policy Optimization) Abdolmaleki et al., arXiv:1806.06920, 2018, with a Mixture-of-Gaussian critic. Both architectures employ a three-block ResNet that computes an eight-dimensional embedding vector for each pixel input. These embeddings are concatenated with the proprioceptive observations referred to above and fed through a three-layer MLP (multilayer perceptron) for computing five-dimensional actions 118.

FIG. 6 shows data collected from the simulated system of FIG. 4B. In this case both architectures were trained on the task description 110 “lift red” over 20,000 episodes. The vertical axis represents the success rate of completion of this task following the training. Three virtual blocks 404b were present: a red block, a green block, and a blue block. The task was to use the simulated robot arm 402b to lift the specified block 404b.

It can be seen that when instructed to “lift red” task the D/E and standard architectures both have similarly high rates of success. However, the standard architecture is unable to lift an alterative block. By contrast, due to the dispatcher 102 filtering the image that is provided to the executor 104 to abstract away the color of the target block 404b, the D/E architecture 100 is able to perform the tasks “lift green” and “lift blue” without any further training or data collection. This may be considered a zero effort transfer to these new tasks.

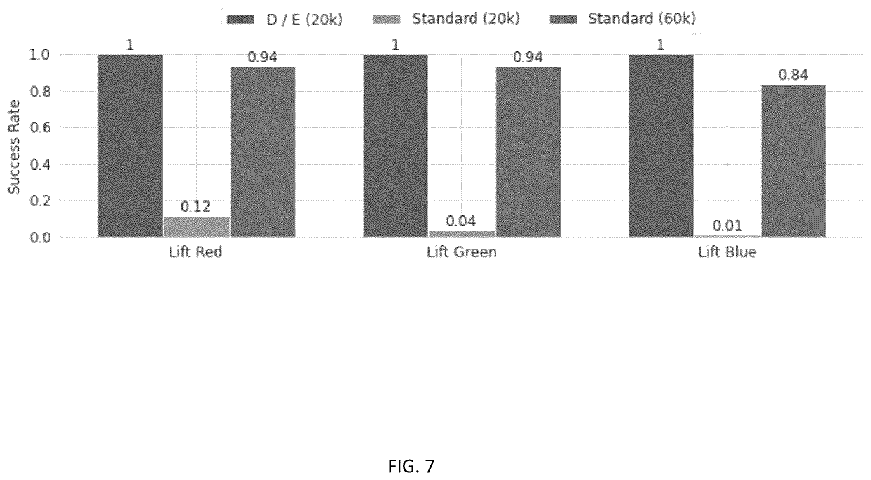

FIG. 7 shows further data collected from the simulated system of FIG. 4B. In this case there were once again three virtual blocks 404b, color red, green, and blue respectively. Both the standard and D/E architectures received multi-task training to lift a specified block using the robot arm 402b, with the standard architecture receiving an additional input specifying the target block color.

It can be seen that after 20 k training episodes the D/E architecture 100 is able to consistently perform all three tasks. This is due to the fact that the same executor instruction 114 can be used regardless of the color of the target block 404b as described above, so that this multi-task training effectively functions as single-task training for the executor 104. By contrast, the standard monolithic architecture shows low success rates after 20 k episodes, requiring 60 k episodes to achieve high success rates at all three tasks.

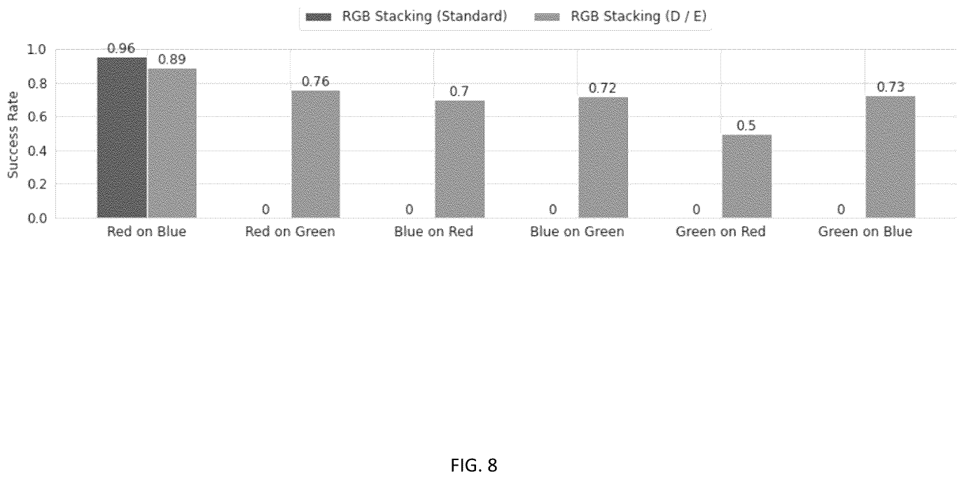

FIG. 8 shows data collected from the real-world system of FIG. 4A. In this case training was performed using a student-teacher scheme, with the teacher being a policy that had been fully self-learned on real robot experience to stack the red object on the blue object on the five different object sets of the RGB stacking benchmark (Lampe et al, 2023). The data shown relates to stacking objects from these object sets in various color combinations as shown, averaged over the five object sets. The “standard” architecture in this case is the teacher policy.

It can be seen that distilling the teacher policy to a controller following the D/E architecture 100 results in a small decrease in effectiveness is stacking the red object on the blue object, from 96% to 89%. However, the D/E architecture 100 is then able to achieve a success rate of 50% or higher on every other combination of colors, while the teacher policy could not perform these tasks at all.

The benefits of generalizability of the D/E architecture 100 can therefore be seen to extend to real-world systems such as the system of FIG. 4A, and to a wider variety of stacking tasks.

### Example Application

Some further example applications of the above described techniques follow. In general implementations of the techniques, e.g., of the described controller system 100 and method, can be used for any sort of machine control task. More generally the implementations can be used in any application where conventional set-point or other control techniques might otherwise be employed. The described techniques are particularly useful in domains where being able to learn from just a few interactions with the environment is helpful.

In some implementations, the environment 108 is a real-world environment, the agent 106 is a mechanical agent interacting with the real-world environment, e.g., a robot or an autonomous or semi-autonomous land, air, or sea vehicle operating in or navigating through the environment, and the actions 118 are actions taken by the mechanical agent in the real-world environment to perform the task. For example, the mechanical agent, e.g., robot, may be interacting with the environment 108 to accomplish a specific task, e.g., to locate or manipulate an object of interest in the environment 108 or to move an object of interest to a specified location in the environment 108 or to navigate to a specified destination in the environment 108.

In these implementations, the observations 112 may include, e.g., one or more of: images, object position data, and sensor data from the sensor 310 to capture observations 112 as the agent 106 interacts with the environment 108, for example sensor data from an image, distance, or position sensor 310 or from an actuator. For example in the case of a robot, the observations 112 may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations 112 may similarly include one or more of the position, linear or angular velocity, force, torque or acceleration, and global or relative pose of one or more parts of the agent 106. The observations 112 may be defined in 1, 2 or 3 dimensions, and may be absolute and/or relative observations 112. The observations 112 may also include, for example, sensed electronic signals such as motor current or a temperature signal; and/or image or video data for example from a camera or a LIDAR sensor, e.g., data from sensors 310 of the agent 106 or data from sensors 310 that are located separately from the agent 106 in the environment 108.

In these implementations, the actions 118 may be control signals to control the robot or other mechanical agent 106, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent 106. The control signals may also or instead include electronic control data such as motor control data, or more generally data for controlling one or more electronic devices within the environment 108 the control of which has an effect on the observed state of the environment 108. For example in the case of an autonomous or semi-autonomous land or air or sea vehicle the control signals may define actions to control navigation, e.g., steering, and movement, e.g., braking and/or acceleration of the vehicle.

At each time step that an agent 106 interacts with an environment 108 to perform a task, the agent 106 can receive a reward based on the current state of the environment 108 and the action 118 performed by the agent 106 at the time step. Generally, the reward may be represented as a numerical value. The reward can be based on any event in or aspect of the environment 108. For example, the reward may indicate whether the agent 106 has accomplished a task (e.g., picking up or manipulating an object or navigating to a target location in the environment 108) or the progress of the agent 106 toward accomplishing the task.

More generally the agent 106 may comprise any kind of machine in a real-world environment 108, e.g., a fusion reactor, or a medical imaging system. The observations 112 may be any observations that relate to operation of the machine, e.g., image observations of a plasma in the machine or observations of a magnetic field in an MRI (Magnetic Resonance Imaging) system, or more generally observations of temperature, pressure, flow rate, position, speed, electrical conditions, mechanical conditions, or any other measurable attribute of the machine. The actions 118 may be any actions 118 that control the machine in response to the observations 112, e.g., to control a configuration of the plasma or magnetic field, or more generally any action 118 to control temperature, pressure, flow rate, position, speed, electrical conditions, mechanical conditions (e.g., using an electro-mechanical actuator) or any other aspect of the machine.

In some implementations the environment 108 is a simulation of the above-described real-world environment, and the agent 106 is implemented as one or more computers interacting with the simulated environment 108. For example the simulated environment 108 may be a simulation of a robot or vehicle or machine and the reinforcement learning system may be trained on the simulation and then, once trained, used in the real-world.

In some implementations the environment 108 is a real-world manufacturing environment 108 for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent 106 may comprise an electronic agent configured to control a manufacturing unit, or a machine such as a robot, that operates to manufacture the product. That is, the agent 106 may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent 106 may comprise a task to manufacture the product or an intermediate version or component thereof. As another example, a task performed by the agent 106 may comprise a task to control, e.g., minimize, use of a resource such as a task to control electrical power consumption, or water consumption, or the consumption of any material or consumable used in the manufacturing process.

The actions 118 may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general the actions 118 may be any actions 118 that have an effect on the observed state of the environment 108, e.g., actions 118 configured to adjust any of the sensed parameters described below. These may include actions 118 to adjust the physical or chemical conditions of a manufacturing unit, or actions 118 to control the movement of mechanical parts of a machine or joints of a robot. The actions 118 may include actions imposing operating conditions on a manufacturing unit or machine, or actions 118 that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use of a resource the metric may comprise any metric of usage of the resource.

In general observations 112 of a state of the environment 108 may comprise any electronic signals representing the functioning of electronic and/or mechanical items of equipment. For example a representation of the state of the environment 108 may be derived from observations 112 made by sensors 310 sensing a state of the manufacturing environment, e.g., sensors 310 sensing a state or configuration of the manufacturing units or machines, or sensors 310 sensing movement of material between the manufacturing units or machines. As some examples such sensors 310 may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors 310 to capture image or video observations of the manufacturing units or of the machines or movement; or any other appropriate type of sensor 310. In the case of a machine such as a robot the observations 112 from the sensors 310 may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors 310 such as these may be part of or located separately from the agent 106 in the environment 108, as described above with reference to FIG. 3.

In some implementations the environment 108 is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment such as a heater, a cooler, a humidifier, or other hardware that modifies a property of air in the real-world environment. The task may comprise a task to control, e.g., minimize, use of a resource, such as a task to control electrical power consumption, or water consumption. The agent 106 may comprise an electronic agent configured to control operation of the items of equipment, or to control operation of the ancillary, e.g., environmental, control equipment.

In general the actions 118 may be any actions 118 that have an effect on the observed state of the environment 108, e.g., actions 118 configured to adjust any of the sensed parameters described below. These may include actions 118 to control, or to impose operating conditions on, the items of equipment or the ancillary control equipment, e.g., actions 118 that result in changes to settings to adjust, control, or switch on or off the operation of an item of equipment or an item of ancillary control equipment.

In general observations 112 of a state of the environment 108 may comprise any electronic signals representing the functioning of the facility or of equipment in the facility. For example a representation of the state of the environment 108 may be derived from observations 112 made by any sensors 310 sensing a state of a physical environment of the facility or observations 112 made by any sensors 310 sensing a state of one or more of items of equipment or one or more items of ancillary control equipment. These include sensors 310 configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the environment 108 is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent 106 may comprise an electronic agent configured to control the generation of electrical power by the facility or the coupling of generated electrical power into the grid. The actions 118 may comprise actions 118 to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations 112 of a state of the environment 108 may comprise any electronic signals representing the electrical or mechanical functioning of power generation equipment in the power generation facility. For example a representation of the state of the environment 108 may be derived from observations 112 made by any sensors 310 sensing a physical or electrical state of equipment in the power generation facility that is generating electrical power, or the physical environment of such equipment, or a condition of ancillary equipment supporting power generation equipment. Such observations 112 may thus include observations 112 of wind levels or solar irradiance, or of local time, date, or season. Such sensors 310 may include sensors configured to sense electrical conditions of the equipment such as current, voltage, power or energy; temperature or cooling of the physical environment; fluid flow; or a physical configuration of the equipment; and observations 112 of an electrical condition of the grid, e.g., from local or remote sensors 310. Observations 112 of a state of the environment 108 may also comprise one or more predictions regarding future conditions of operation of the power generation equipment such as predictions of future wind levels or solar irradiance or predictions of a future electrical condition of the grid.

As another example, the environment 108 may be a chemical synthesis or protein folding environment such that each state is a respective state of a protein chain or of one or more intermediates or precursor chemicals and the agent 106 is a computer system for determining how to fold the protein chain or synthesize the chemical. In this example, the actions 118 are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent 106 may be a mechanical agent that indirectly performs or controls the protein folding actions, or chemical synthesis steps, e.g., by controlling synthesis steps selected by the system automatically without human interaction. The observations 112 may comprise direct or indirect observations 112 of a state of the protein or chemical/intermediates/precursors and/or may be derived from simulation. Thus the system may be used to automatically synthesize a protein with a particular function such as having a binding site shape, e.g., a ligand that binds with sufficient affinity for a biological effect that it can be used as a drug. For example, e.g., it may be an agonist or antagonist of a receptor or enzyme; or it may be an antibody configured to bind to an antibody target such as a virus coat protein, or a protein expressed on a cancer cell, e.g., to act as an agonist for a particular receptor or to prevent binding of another ligand and hence prevent activation of a relevant biological pathway.

In a similar way the environment 108 may be a drug design environment such that each state is a respective state of a potential pharmaceutically active compound, i.e., a drug, and the agent 106 is a computer system for determining elements of the pharmaceutically active compound and/or a synthetic pathway for the pharmaceutically active compound. The drug/synthesis may be designed based on a reward derived from a target for the pharmaceutically active compound, for example in simulation. The agent 106 may be, or may include, a mechanical agent that performs or controls synthesis of the pharmaceutically active compound; and hence a process as described herein may include making such a pharmaceutically active compound.

For example the environment 108 may be an in silico drug design environment, e.g., a molecular docking environment, and the agent 106 may be a computer system for determining elements or a chemical structure of the drug. The drug may be a small molecule or biologic drug. An observation 112 may be an observation 112 of a simulated combination of the drug and a target of the drug. An action 118 may be an action 118 to modify the relative position, pose or conformation of the drug and drug target (or this may be performed automatically) and/or an action 118 to modify a chemical composition of the drug and/or to select a candidate drug from a library of candidates. One or more rewards may be defined based on one or more of: a measure of an interaction between the drug and the drug target, e.g., of a fit or binding between the drug and the drug target; an estimated potency of the drug; an estimated selectivity of the drug; an estimated toxicity of the drug; an estimated pharmacokinetic characteristic of the drug; an estimated bioavailability of the drug; an estimated ease of synthesis of the drug; and one or more fundamental chemical properties of the drug. A measure of interaction between the drug and drug target may depend on, e.g., a protein-ligand bonding, van der Waal interactions, electrostatic interactions, and/or a contact surface region or energy; it may comprise, e.g., a docking score. Following identification of elements or a chemical structure of a drug in simulation, the method may further comprise making the drug. The drug may be made partly or completely by an automatic chemical synthesis system.

In some applications the agent 106 may be a software agent, i.e., a computer program, configured to perform a task. For example the environment 108 may be a circuit or an integrated circuit design or routing environment and the agent 106 may be configured to perform a design or routing task for routing interconnection lines of a circuit or of an integrated circuit, e.g., an ASIC. The reward(s) may then be dependent on one or more routing metrics such as interconnect length, resistance, capacitance, impedance, loss, speed or propagation delay; and/or physical line parameters such as width, thickness or geometry, and design rules. The reward(s) may also or instead include one or more reward(s) relating to a global property of the routed circuitry, e.g., component density, operating speed, power consumption, material usage, a cooling requirement, level of electromagnetic emissions, and so forth. The observations 112 may be, e.g., observations 112 of component positions and interconnections; the actions 118 may comprise component placing actions, e.g., to define a component position or orientation and/or interconnect routing actions, e.g., interconnect selection and/or placement actions. The task may be, e.g., to optimize circuit operation to reduce electrical losses, local or external interference, or heat generation, or to increase operating speed, or to minimize or optimize usage of available circuit area. The method may include making the circuit or integrated circuit to the design, or with interconnection lines routed as determined by the method.

In some applications the agent 106 is a software agent and the environment 108 is a real-world computing environment. In one example the agent 106 manages distribution of tasks across computing resources, e.g., on a mobile device and/or in a data center. In these applications, the observations 112 may include observations 112 of computing resources such as compute and/or memory capacity, or Internet-accessible resources; and the actions 118 may include assigning tasks to particular computing resources. The reward(s) may be configured to maximize or minimize one or more of: utilization of computing resources, electrical power, bandwidth, and computation speed.

In another example the software agent manages the processing, e.g., by one or more real-world servers, of a queue of continuously arriving jobs. The observations 112 may comprise observations 112 of the times of departures of successive jobs, or the time intervals between the departures of successive jobs, or the time a server takes to process each job, e.g., the start and end of a range of times, or the arrival times, or time intervals between the arrivals, of successive jobs, or data characterizing the type of job(s). The actions 118 may comprise actions 118 that allocate particular jobs to particular computing resources; the reward(s) may be configured to minimize an overall queueing or processing time or the queueing or processing time for one or more individual jobs, or in general to optimize any metric based on the observations.

As another example the environment 108 may comprise a real-world computer system or network, the observations 112 may comprise any observations 112 characterizing operation of the computer system or network, the actions 118 performed by the software agent may comprise actions 118 to control the operation, e.g., to limit or correct abnormal or undesired operation, e.g., because of the presence of a virus or other security breach, and the reward(s) may comprise any metric(s) that characterizing desired operation of the computer system or network.

In some applications, the environment 108 is a real-world computing environment and the software agent manages distribution of tasks/jobs across computing resources, e.g., on a mobile device and/or in a data center. In these implementations, the observations 112 may comprise observations 112 that relate to the operation of the computing resources in processing the tasks/jobs, the actions 118 may include assigning tasks/jobs to particular computing resources, and the reward(s) may relate to one or more metrics of processing the tasks/jobs using the computing resources, e.g., metrics of usage of computational resources, bandwidth, or electrical power, or metrics of processing time, or numerical accuracy, or one or more metrics that relate to a desired load balancing between the computing resources.

In some applications the environment 108 is a data packet communications network environment, and the agent 106 is part of a router to route packets of data over the communications network. The actions 118 may comprise data packet routing actions and the observations 112 may comprise, e.g., observations 112 of a routing table which includes routing metrics such as a metric of routing path length, bandwidth, load, hop count, path cost, delay, maximum transmission unit (MTU), and reliability. The reward(s) may be defined in relation to one or more of the routing metrics, i.e., configured to maximize one or more of the routing metrics.

In some other applications the environment 108 is an Internet or mobile communications environment and the agent 106 is a software agent which manages a personalized recommendation for a user. The observations 112 may comprise previous user actions taken by the user, e.g., features characterizing these; the actions 118 may include actions 118 recommending items such as content items to a user. The reward(s) may be configured to maximize one or more of: an estimated likelihood that the user will respond favorably to being recommended the (content) item, a suitability unsuitability of one or more recommended items, a cost of the recommended item(s), and a number of recommendations received by the user, optionally within a time span.

As a further example, the actions 118 may include presenting advertisements, the observations 112 may include advertisement impressions or a click-through count or rate, and the reward may characterize previous selections of items or content taken by one or more users.

In some cases, the observations 112 may include textual or spoken instructions provided to the agent 106 by a third-party (e.g., an operator of the agent). For example, the agent 106 may be an autonomous vehicle, and a user of the autonomous vehicle may provide textual or spoken instructions to the agent 106 (e.g., to navigate to a particular location).

As another example the environment 108 may be an electrical, mechanical or electro-mechanical design environment, e.g., an environment 108 in which the design of an electrical, mechanical or electro-mechanical entity is simulated. The simulated environment 108 may be a simulation of a real-world environment in which the entity is intended to work. The task may be to design the entity. The observations 112 may comprise observations 112 that characterize the entity, i.e., observations 112 of a mechanical shape or of an electrical, mechanical, or electro-mechanical configuration of the entity, or observations 112 of parameters or properties of the entity. The actions 118 may comprise actions 118 that modify the entity, e.g., that modify one or more of the observations 112. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus the design of an entity may be optimized, e.g., by reinforcement learning, and then the optimized design output for manufacturing the entity, e.g., as computer executable instructions; an entity with the optimized design may then be manufactured.

As previously described the environment 108 may be a simulated environment. Generally in the case of a simulated environment the observations 112 may include simulated versions of one or more of the previously described observations 112 or types of observations 112 and the actions 118 may include simulated versions of one or more of the previously described actions 118 or types of actions 118. For example the simulated environment may be a motion simulation environment, e.g., a driving simulation or a flight simulation, and the agent 106 may be a simulated vehicle navigating through the motion simulation. In these implementations, the actions 118 may be control inputs to control the simulated user or simulated vehicle. Generally the agent 106 may be implemented as one or more computers interacting with the simulated environment.

The simulated environment may be a simulation of a particular real-world environment and agent 106. For example, the system may be used to select actions 118 in the simulated environment during training or evaluation of the system and, after training, or evaluation, or both, are complete, may be deployed for controlling a real-world agent 106 in the particular real-world environment that was the subject of the simulation. This can avoid unnecessary wear and tear on and damage to the real-world environment or real-world agent 106 and can allow the controller system 100 to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations 112 of the simulated environment relate to the real-world environment, and the selected actions 118 in the simulated environment relate to actions to be performed by the mechanical agent in the real-world environment.

In some implementations the observations 112 are observations 112 of a real-world environment 108 in which a human is performing a task, e.g., an image observation from an image sensor 310 and/or a language observation from a speech recognition system; and the actions 118 are language actions that control (instruct) the human, e.g., using natural language or images, to perform actions 118 in the real-world environment 108 to perform the task. A language action may be an action that outputs a natural language sentence, e.g., by defining a sequence of language tokens, e.g., words or wordpieces, to be emitted at sequential time steps.

Thus the agent 106 may comprise a user interface device such as a digital device (a “digital assistant”), e.g., a smart speaker or smart display or other device, e.g., with a natural language input and/or output, that controls (instructs) a human user to perform a task. In general such a digital device can be a mobile device with a natural language interface to receive natural language requests from a human user and to provide natural language responses. It may also include a vision based input, e.g., a camera 310 and/or display screen. The digital device may include a language model or language generation neural network system either stored locally, or accessed remotely, or both. The user interface device may comprise, e.g., a mobile device, a keyboard (and optionally display), or a speech-based input mechanism 310, e.g., to input audio data characterizing a speech waveform of speech representing the input from the user in the natural or computer language and to convert the audio data into tokens representing the speech in the natural or computer language, i.e., representing a transcription of the spoken input. The user interface can also include a text or speech-based output, e.g., a display and/or a text-to-speech subsystem.

Thus in implementations the agent actions 118 contribute to performing the task. A monitoring system 310, e.g., a video camera system, may be provided for monitoring the action (if any) which the user actually performs at each time step in case, e.g., due to human error, it is different from the action 118 which the reinforcement learning system instructed the user to perform. The monitoring system 310 can be used to determine whether the task has been completed. Training data may be collected by record the actions which the user actually performed based on the instruction. The reward value of an action 118 may be generated, for example, by comparing the action the user took with a corpus of data showing a human expert performing the task, e.g., using techniques known from imitation learning, or in some other way, e.g., using a trained reward model. A system of this type can learn how to guide a human to perform a task, e.g., avoiding difficult to perform actions.

Optionally, in any of the above implementations, the observation 112 at any given time step may include data from a previous time step that may be beneficial in characterizing the environment 108, e.g., the action 118 performed at the previous time step, the reward received at the previous time step, or both.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them. Thus a system, artificial neural network, or trained artificial neural network as described herein, can be implemented in hardware using electronic circuitry, e.g., in a physical box. Similarly computer code as described herein can be code to emulate such hardware or code for a hardware description language.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method of controlling an agent acting in an environment to perform a task of a plurality of possible tasks, the method comprising:
obtaining a task description, wherein the task description identifies the task to be performed; and, at each of a plurality of sub-task execution time steps:
processing the task description and an observation characterizing a state of the environment at the time step, using a dispatcher neural network system, to generate an executor instruction,
wherein the executor instruction comprises a set of tokens that encodes a representation of aspects of the environment relevant to the sub-task;
processing the executor instruction, using an executor neural network system, to generate an action selection output for performing a set of one or more sub-task actions for executing a sub-task of the task; and
controlling the agent using actions selected according to the action selection output to perform the set of one or more sub-task actions for executing the sub-task.

2. The method of claim 1, wherein
processing the task description and the observation characterizing the state of the environment at the time step, using the dispatcher neural network system, comprises dividing the task into sub-tasks using the dispatcher neural network system and generating the executor instruction by selecting, from the observation characterizing the state of the environment at the time step, a subset of information from the observation relevant to the sub-task being executed at the time step; and wherein
processing the executor instruction, using the executor neural network system, to generate the action selection output comprises processing the subset of information from the observation, relevant to the sub-task being executed at the time step, to generate the action selection output for performing the set of one or more sub-task actions.

3. The method of claim 1, wherein processing the task description and the observation characterizing the state of the environment at the time step, using the dispatcher neural network system, to generate the executor instruction comprises generating the set of tokens such that each token represents one or more aspects of an entity in the environment that is relevant to performing the task.

4. The method of claim 3, wherein generating the set of tokens comprises generating one or more respective tokens to represent the one or more aspects of each respective entity in the environment, wherein different tokens represent different respective entities in the environment.

5. The method of claim 4, wherein generating respective tokens representing different respective entities in the environment comprises processing the observation characterizing the state of the environment at the time step and the task description, using the dispatcher neural network system, to select a subset of the entities in the environment based on the task description, for use in performing the sub-task.

6. The method of claim 4, wherein the observation characterizing the state of the environment at the time step comprises an image observation from one or more image sensors; and wherein generating respective tokens representing different respective entities in the environment comprises:
processing the task description and pixels of the image observation at the time step, using the dispatcher neural network system, to select one or more objects in the image observation, based on the task description, for use in performing the sub-task; and
generating the set of tokens such that each of the one of the one or more objects is characterized by one or more of the tokens.

7. The method of claim 6, wherein a location of each of the one or more objects is characterized by a respective token.

8. The method of claim 6, wherein the observation characterizing the state of the environment at the time step includes an additional sensor observation from one or more sensors in the environment; the method further comprising:
processing the additional sensor observation using a sensor encoder neural network to generate a set of sensor feature vectors representing the additional sensor observation; and
processing the executor instruction and the set of sensor feature vectors, using the executor neural network system, to generate the action selection output.

9. The method of claim 1, wherein generating the set of tokens comprises selecting each token from an observation description language comprising tokens that describe one or more of: objects represented by the observation, aspects of objects represented by the observation, and a scene represented by the observation.

10. The method of claim 1, wherein at least some tokens of the set of tokens encode a learned representation of the aspects of the environment relevant to the sub-task.

11. The method of claim 1, wherein the set of tokens includes an executor identifier token to identify one of a plurality of the executor neural network systems; the method further comprising:
processing the task description and the observation characterizing the state of the environment at the time step, using the dispatcher neural network system, to generate the executor instruction including the executor identifier token; and
processing the executor instruction using the identified executor neural network system to generate the action selection output.

12. The method of claim 1, wherein the task description comprises a text sequence that characterizes the task to be performed by the agent in the environment; the method further comprising:
generating an encoded representation of the text sequence; wherein
processing the task description and the observation characterizing the state of the environment at the time step, using the dispatcher neural network system comprises processing the observation characterizing the state of the environment conditioned on the encoded representation of the text sequence to generate the executor instruction comprising the set of tokens; and wherein
the set of tokens comprises a sequence of tokens each representing a different respective aspect of the observation characterizing the state of the environment.

13. The method of claim 1, wherein the task description comprises a text sequence that characterizes the task to be performed by the agent in the environment, wherein dispatcher neural network system comprises a transformer-based multimodal machine learning model having a first modality input to receive the text sequence and a second modality input to receive the observation characterizing the state of the environment at the time step, and the method further comprising:
jointly processing, using the transformer-based multimodal machine learning model, an encoded version of the text sequence and an encoded version of the observation to generate the executor instruction.

14. The method of claim 1, further comprising:
training at least the executor neural network system to perform one or more sub-tasks of the plurality of tasks using a reinforcement learning technique based on rewards provided by the dispatcher neural network system to the executor neural network system.

15. The method of claim 1, further comprising:
training at least the executor neural network system to perform one or more sub-tasks of the plurality of tasks using demonstration data from one or more demonstration agents trained to perform a particular example of the one or more sub-tasks, by:
training at least the executor neural network system to perform the one or more sub-tasks using an imitation learning technique based on training data comprising the demonstration data characterizing interactions of the one or more demonstration agents performing the particular example of the one or more sub-tasks in a corresponding environment to the environment of the agent.

16. The method of claim 1, wherein the environment is a real-world environment, the observations comprise observations from one or more sensors in the real-world environment, the agent comprises a machine operating in the real-world environment to perform the task, and the sub-task actions are actions of the machine in the real-world environment.

17. The method of claim 1, further comprising:
implementing the dispatcher neural network system on a first hardware computing device;
implementing the executor neural network system on a second, different hardware computing device, in communication with the first hardware computing device to receive the executor instruction; and
using the first hardware computing device to process the observation characterizing a state of the environment at a next sub-task execution time step to generate the executor instruction for the next sub-task execution time step in parallel with the processing the executor instruction, using the executor neural network system on the second hardware computing device, to generate an action selection output for performing the set of one or more sub-task actions for a current sub-task execution time step.

18. The method of claim 1, further comprising:
implementing the dispatcher neural network system on a first hardware computing device, and wherein generating the executor instruction comprising the set of tokens comprises selecting each token from an observation description language;
implementing the executor neural network system on a second, different hardware computing device, in communication with the first hardware computing device to receive the executor instruction; and
sharing the dispatcher neural network system with one or more other agents in one or more other respective environments to perform a respective task, wherein the sharing comprises, for each other agent, processing a task description for the respective task of the other agent and an observation characterizing a state of the respective environment of the other agent at a time step, using the dispatcher neural network system, to generate a respective executor instruction for the other agent.

19. A system comprising:
one or more computers; and
one or more storage devices communicatively coupled to the one or more computers, wherein the one or more storage devices store instructions that, when executed by the one or more computers, cause the one or more computers to perform operations for controlling an agent acting in an environment to perform a task of a plurality of possible tasks, the operations comprising:
obtaining a task description, wherein the task description identifies the task to be performed; and, at each of a plurality of sub-task execution time steps:
processing the task description and an observation characterizing a state of the environment at the time step, using a dispatcher neural network system, to generate an executor instruction,
wherein the executor instruction comprises a set of tokens that encodes a representation of aspects of the environment relevant to the sub-task;
processing the executor instruction, using an executor neural network system, to generate an action selection output for performing a set of one or more sub-task actions for executing a sub-task of the task; and
controlling the agent using actions selected according to the action selection output to perform the set of one or more sub-task actions for executing the sub-task.

20. A computer-implemented machine control system, for controlling a machine acting in a real-world environment to perform a task of a plurality of possible tasks, the system comprising:
a task description input to receive a task description, wherein the task description identifies the task to be performed;
a sensor input to receive, from one or more sensors in the real-world environment, an observation characterizing a state of the environment; and
wherein the system is configured to, at each of a plurality of time steps:
process the task description and an observation characterizing a state of the environment at the time step, using a dispatcher neural network system, to generate an executor instruction,
wherein the executor instruction comprises a set of tokens that encodes a representation of relevant aspects of the environment to the task;
process the executor instruction, using an executor neural network system, to generate an action selection output for performing a set of one or more sub-task actions for executing a sub-task of the task; and
generate, using the action selection output, a control output for controlling the machine to perform the set of one or more sub-task actions for executing the sub-task.

21. The system of claim 20, wherein the one or more sensors comprise an image sensor, wherein the observation characterizing the state of the environment at the sub-task execution time step comprises an image observation from image sensor; and wherein generating respective tokens representing different respective entities in the environment comprises:
processing the task description and pixels of the image observation of the environment at the sub-task execution time step, using the dispatcher neural network system, to select one or more objects in the image observation, based on the task description, for use in performing the task; and
generating the set of tokens such that each token characterizes one of the one or more objects.
